(19) United States
(12) Patent Application Publication
(10) Pub. No.: US 2025/0187961 A1
(43) Pub. Date: Jun. 12, 2025

(54) RAINWATER GARDEN WITH REDUCED NITROUS OXIDE EMISSION

(71) Applicant: Chongqing University, Chongqing (CN)

(72) Inventors: Hongxiang CHAI, Chongqing (CN); Huan XIAO, Chongqing (CN); Haiyuan MA, Chongqing (CN); Cheng CHENG, Chongqing (CN); Wenlin ZHAO, Chongqing (CN); Zhiyu SHAO, Chongqing (CN); Lei CHEN, Chongqing (CN)

(21) Appl. No.: 18/637,395

(22) Filed: Apr. 16, 2024

(30) Foreign Application Priority Data
Dec. 8, 2023 (CN) 202311679821.8

(51) Int. Cl. C02F 3/32; C02F 1/00; C02F 3/00; C02F 3/30; C02F 103/00

(52) U.S. Cl. CPC C02F 3/327; C02F 3/306; C02F 2001/007; C02F 2003/003; C02F 2103/001; C02F 2203/006

(57) ABSTRACT

A rainwater garden including: a bioretention area; a rainwater collection area; and a first perforated drainage pipe. The bioretention area includes, from bottom up, a gravel layer, a transition layer, a chalcopyrite substrate layer, a biochar substrate layer, a planting layer, a cover layer, and a water storage layer. The first perforated drainage pipe is disposed in the gravel layer. The first perforated drainage pipe includes an outlet end extending to connect to the rainwater collection area; and the outlet end is flush with a top surface of the chalcopyrite substrate layer.

### CROSS-REFERENCE TO RELATED APPLICATIONS

Pursuant to 35 U.S.C. § 119 and the Paris Convention Treaty, this application claims foreign priority to Chinese Patent Application No. 202311679821.8 filed Dec. 8, 2023, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, MA 02142.

### BACKGROUND

The disclosure relates to the field of rainwater garden with reduced nitrous oxide emission.

In recent years, the development of urbanization and engineering construction has led to a significant increase in the impervious surface area of cities. The urban subsurface environment has been greatly affected, and the pollution caused by surface runoff needs to be solved. Dissolved nitrogen is a typical surface pollutant source, including inorganic nitrogen such as ammonia nitrogen, nitrate nitrogen, nitrite nitrogen, and organic nitrogen. The surface pollutant source mixing with the runoff flows into the urban water body, resulting in a series of environmental safety problems such as eutrophication, black stinking water body.

Rainwater gardens, also known as bioretention facilities, rainwater biofilters, etc., are runoff treatment facilities for rainwater storage and purification, and are formed by a combination of plants, substrates, and microorganisms to purify water through plant absorption, retention and adsorption, and biodegradation. Nitrous oxide (N₂O) is a by-product and intermediate product of the runoff denitrification process in rainwater gardens, and it is a strong greenhouse effect gas that contributes to global warming and ozone layer depletion.

There are at least two problems associated with existing rainwater gardens. First, some rainwater gardens purify water through physical filtration, and remove particulate pollutants in rainwater through filler filtration; however, dissolved pollutants, especially dissolved nitrogen, cannot be removed. Second, some rainwater gardens are equipped with aerobic and anoxic or anaerobic zones to extend water retention time, which facilitates the system's nitrogen removal by denitrification. However, nitrous oxide (N₂O), an intermediate product and a byproduct of denitrification process, is produced in the rainwater gardens and not treated, leading to greenhouse effect.

### SUMMARY

The disclosure provides a rainwater garden comprising: a bioretention area; a rainwater collection area; and a first perforated drainage pipe. The bioretention area comprises, from bottom up, a gravel layer, a transition layer, a chalcopyrite substrate layer, a biochar substrate layer, a planting layer, a cover layer, and a water storage layer; the first perforated drainage pipe is disposed in the gravel layer; the first perforated drainage pipe comprises an outlet end extending to connect to the rainwater collection area; and the outlet end is flush with a top surface of the chalcopyrite substrate layer.

In a class of this embodiment, the rainwater garden further comprises a sedimentation area and an initial runoff disposal area; the sedimentation area and the initial runoff disposal area are disposed outside the cover layer of the bioretention area; the sedimentation area is disposed outside the initial runoff disposal area; pebbles are disposed on bottom parts of the sedimentation area and the initial runoff disposal area; the initial runoff disposal area is sloped; an overflow pipe is vertically disposed in the initial runoff disposal area and a second perforated drainage pipe is disposed flat on a bottom end of the initial runoff disposal area; the overflow pipe is connected to the second perforated drainage pipe; and an outlet of the second perforated drainage pipe is connected to a municipal rainwater pipe network.

In a class of this embodiment, a submersible pump is disposed in the rainwater collection area; a return pipe is connected to a water outlet of the submersible pump; an inspection well is disposed on a top end of the rainwater collection area; and a drainage pipe is disposed on a side wall of the rainwater collection area.

In a class of this embodiment, the chalcopyrite substrate layer has a thickness of 300-500 mm, filled with a first filler comprising chalcopyrite and quartz sand; a particle size of the chalcopyrite is 0.5-2 mm, and a particle size of the quartz sand is 0.4-0.6 mm; the chalcopyrite and the quartz sand are mixed in a volume ratio of 1:10, and a permeability of the first filler is greater than 250 mm/h.

In a class of this embodiment, the biochar substrate layer has a thickness of 200-300 mm, filled with a second filler comprising biochar and quartz sand; the biochar has a particle size of 0.5-1 mm, and the quartz sand has a particle size of 0.4-0.6 mm; the biochar and the quartz sand are mixed in a volume ratio of 1:10, and a permeability of the second filler is greater than 200 mm/h.

In a class of this embodiment, the planting layer has a thickness greater than 300 mm and is filled with a third filler comprising sandy loam and quartz sand; a particle size of the sandy loam is 0.1-0.5 mm, and a particle size of the quartz sand is 0.4-0.6 mm; the sandy loam and the quartz sand are mixed in a volume ratio of 1:5, and a permeability of the third filler is greater than 150 mm/h; and the planting layer comprises plants.

In a class of this embodiment, the cover layer has a thickness of 50-100 mm, and comprises sawdust, tree bark, or a combination thereof.

In a class of this embodiment, the transition layer is a substrate protective layer with a thickness of 50-100 mm, filled with quartz sand with a particle size of 0.4-0.6 mm; the gravel layer is a drainage layer with a thickness of 200-300 mm and a gravel particle size of 50-80 mm.

The following advantages are associated with the rainwater garden of the disclosure.

1. The initial runoff disposal area and the sedimentation area can effectively intercept large particles of sands and sediments carried in the rainwater runoff, slowing down the clogging of the substrate layer in the bioretention area, and at the same time abandoning highly polluted rainwater at the initial stage, which is conducive to the growth and health of plants in the rainwater garden.

2. The synergistic denitrification of the biochar substrate layer and chalcopyrite substrate layer in the bioretention zone: the complex porous structure and negatively charged surface of the upper layer biochar enhance the removal of organic nitrogen and ammonia nitrogen in the rainwater garden; the dissolution of chalcopyrite in the lower layer produces sulfur, which promotes autotrophic denitrification. At the same time, combined with organic matter in the cover layer, a mixed autotrophic denitrification and heterotrophic denitrification system is formed in the bioretention area to further strengthen the removal of nitrate nitrogen in the rainwater gardens.

3. The chalcopyrite substrate layer in the bioretention zone is operative to produce copper, promoting the synthesis of nitrous oxide reductase and enhancing its activity. At the same time, chalcopyrite, as a metal mineral, has conductivity, promoting the transfer of electrons between four denitrification enzymes in the system and enhancing the electron acquisition ability of the nitrous oxide reductase. Nitrous oxide is reduced to nitrogen, thereby reducing the emission of nitrous oxide gas from rainwater gardens.

4. The rainwater collection area collects clean rainwater, which is then pumped back to the cover layer through a submersible pump to irrigate vegetation, achieving in-situ treatment and reuse of rainwater.

5. The rainwater garden is green, low-carbon, economically efficient, and easy to operate and maintain.

### BRIEF DESCRIPTION OF THE DRAWINGS

FIG. 1 is a schematic diagram of a rainwater garden in accordance with one embodiment of the disclosure; and

FIG. 2 is a top view of the rainwater garden in FIG. 1.

In the drawings, the following reference numbers are used: 1. Sedimentation area; 2. Initial runoff disposal area; 3. Second perforated drainage pipe; 4. Return pipe; 5. Cover layer; 6. Planting layer; 7. Biochar substrate layer; 8. Chalcopyrite substrate layer; 9. Transition layer; 10. Gravel layer; 11. First perforated drainage pipe; 12. Rainwater collection area; 13. Submersible pump; 14. Drainage pipe; 15. Inspection well; 16. Overflow pipe; 17. Water storage layer; 18. Bioretention area.

### DETAILED DESCRIPTION

To further illustrate the disclosure, embodiments detailing a rainwater garden are described below. It should be noted that the following embodiments are intended to describe and not to limit the disclosure.

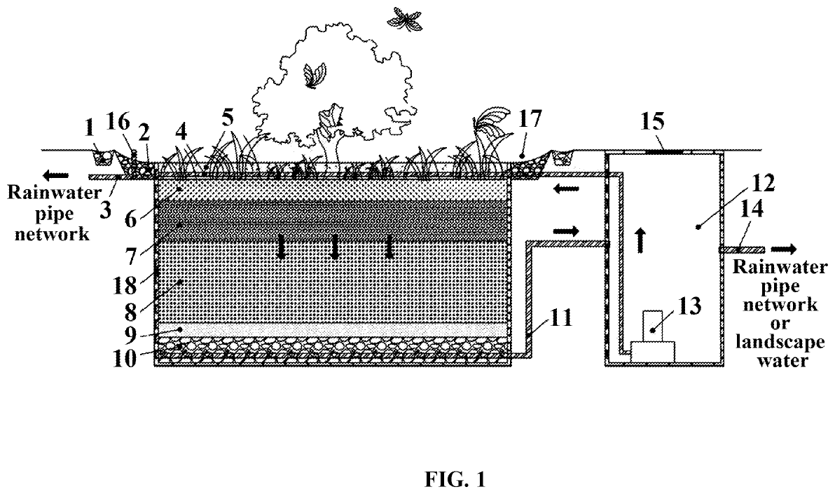

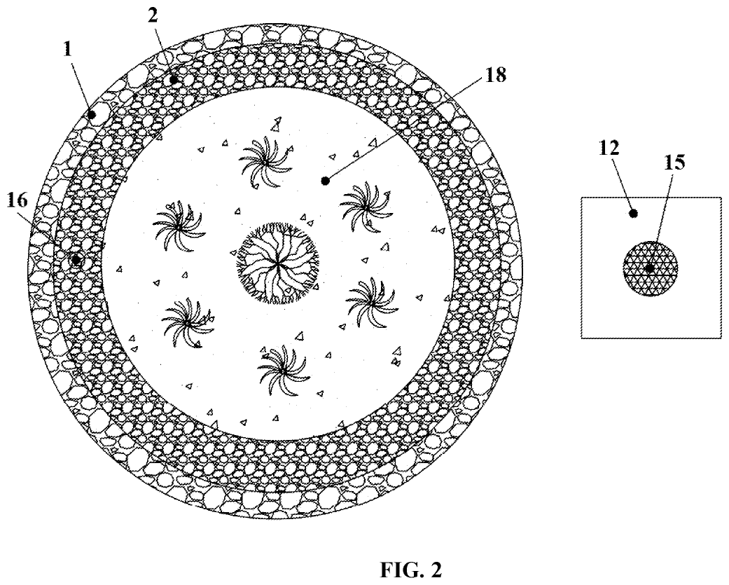

As shown in FIGS. 1-2, the disclosure provides a rainwater garden comprising a sedimentation area 1, an initial runoff disposal area 2, a bioretention area 18, and a rainwater collection area 12. The bioretention area 18 comprises, from bottom up, a gravel layer 10, a transition layer 9, a chalcopyrite substrate layer 8, a biochar substrate layer 7, a planting layer 6, a cover layer 5, and a water storage layer 17. The sedimentation area 1 and the initial runoff disposal area 2 are disposed outside the cover layer of the bioretention area 18. The pebbles are disposed on the bottom parts of the sedimentation area 1 and the initial runoff disposal area 2; the initial runoff disposal area 2 is sloped; an overflow pipe 16 is vertically disposed in the initial runoff disposal area 2 and a second perforated drainage pipe 3 is disposed flat on a bottom end of the initial runoff disposal area 2; the overflow pipe is connected to the second perforated drainage pipe; and an outlet of the second perforated drainage pipe 3 is connected to a municipal rainwater pipe network. The first perforated drainage pipe 11 is disposed in the gravel layer 10; the first perforated drainage pipe 11 comprises an outlet end extending to connect to the rainwater collection area 12; and the outlet end is flush with the top surface of the chalcopyrite substrate layer 8. A submersible pump 13 is disposed in the rainwater collection area 12; a return pipe 4 is connected to a water outlet of the submersible pump 13 for returning the collected clean rainwater to the cover layer 5 of the bioretention area 18 to irrigate the plants; an inspection well 15 is disposed on a top end of the rainwater collection area 12; and a drainage pipe 14 is disposed on a side wall of the rainwater collection area. The drainage pipe is connected to the municipal rainwater pipe network or landscape water.

In one embodiment, the sedimentation area 1 is disposed outside the initial runoff disposal area 2, has a depth of 200 mm and a width of 1000 mm, and is filled with pebbles with a grain size of 100 mm. The initial runoff disposal area 2 connects the sedimentation area 1 and the bioretention area 18, and is a sloping structure with a depth of 300 mm and a slope ratio of 1:4. The initial runoff disposal area is internally filled with pebbles with a grain size of 100 mm, and comprises the vertically-disposed overflow pipe 16 and the horizontally-disposed second perforated drainage pipe 3 in the pebbles, and the two pipes are connected to each other, and the second perforated drainpipe is connected to the municipal rainwater pipeline network.

One end of the overflow pipe 16 is opened above the water storage layer 17, and the other end is connected to the second perforated drainage pipe 3. The height of the overflow pipe 16 is 300 mm, and the pipe diameter is nominal diameter (DN) 300 mm. The second perforated drainage pipe 3 is disposed flat at the bottom of the initial runoff disposal area 2, with a diameter of DN150 mm and a hole diameter of 30 mm. The second perforated drainage pipe is wrapped with two layers of permeable geotextile outside. The middle of the second perforated drainage pipe 3 is connected to the bottom of the overflow pipe 16, and the outlet of the second perforated drainage pipe is connected to the municipal rainwater pipe network.

The role of the overflow pipe 16 is: when rainfall is large, rainwater is stored in the water storage layer 17; the top of the overflow pipe 16 has the same height as the edge of the water storage layer 17; when the stored rainwater is too much, the rainwater overflowing the water storage layer flows downward from the overflow pipe 16 into the second perforated drainage pipe 3 and is discharged into the municipal rainwater pipe network through the second perforated drainage pipe 3.

The function of the initial runoff disposal area 2 is: when the runoff rainwater flows through the initial runoff disposal area 2 to the water storage layer 17 of the bioretention area 18, it will carry pollutants such as sands on the road surface. Before the runoff rainwater enters the bioretention area 18, large particle pollutants such as sands are intercepted in the sedimentation area 1, and then the rainwater flows into the initial runoff disposal area 2. At this time, a part of the rainwater has already flowed into the municipal rainwater network from the second perforated drainage pipe 3. Thus, to some extent, the initial rainwater is purified.

The top of the initial runoff disposal area 2 and the bioretention area 18 together form the water storage layer 17, with a depth of 250 mm. Taking a service area ratio of 5%, the service area of the rainwater garden is 20 times the area of the water storage layer 17.

The cover layer 5 has a thickness of 100 mm, and comprises organic matters such as wood chips and tree barks. The planting layer 6 has a thickness of 300 mm, filled with sandy loam and quartz sand. The particle size of sandy loam is 0.5 mm, and the particle size of quartz sand is 0.6 mm. The sandy loam and quartz sand are mixed in a volume ratio of 1:5, and the permeability rate of the filling material is greater than 150 mm/h. In the planting layer 6, there are locally grown ornamental perennial herbs, shrubs, and trees with strong stress resistance, such as water resistance, drought resistance, and pollution resistance. The biochar substrate layer 7 has a thickness of 300 mm, filled with biochar (charcoal made from high-temperature biomass raw materials, including corn straw, wood chips, etc.) and quartz sand. The particle size of the biochar is 1 mm, and the particle size of the quartz sand is 0.6 mm. The volume ratio of the biochar to quartz sand is 1:10. The permeability rate of the filler of the biochar substrate layer should not be less than 200 mm/h. The chalcopyrite substrate layer 8 has a thickness of 500 mm, filled with chalcopyrite and quartz sand. The particle size of chalcopyrite is 2 mm, and the particle size of quartz sand is 0.6 mm. The chalcopyrite and quartz sand are mixed in a volume ratio of 1:10. The permeability rate of filler of the chalcopyrite substrate layer should not be less than 250 mm/h. The transition layer 9 is a substrate protective layer with a thickness of 100 mm, filled with quartz sand and a particle size of 0.6 mm. The gravel layer 10 is a drainage layer with a thickness of 300 mm and a gravel particle size of 80 mm. A horizontal first perforated drainage pipe 11 is laid in the gravel layer 10. The diameter of the first perforated drainage pipe 11 is DN150 mm, and the aperture of the perforation on the pipe is 30 mm. The outside of the first perforated drainage pipe is wrapped with two layers of permeable geotextile.

The submersible pump 13 is disposed in the rainwater collection area 12; the return pipe 4 is connected to the water outlet of the submersible pump 13. The diameter of the return pipe 4 is DN150 mm, and the part of the return pipe in the cover layer 5 of the bioretention area 18 comprises uniformly distributed holes, with a diameter of 30 mm. The outer part of the return pipe is wrapped with two layers of permeable geotextile. The drainage pipe 14 on the side wall of the rainwater collection area 12 is lower than the outlet of the first perforated drainage pipe 11, with a diameter of DN 150 mm.

The working process of removing dissolved nitrogen and reducing nitrous oxide gas emissions of the disclosure is detailed as follows:

1. Removing dissolved nitrogen: in the sedimentation area 1 and the initial runoff disposal area 2, large particulate matters and pollutants of the rainwater are removed. The rainwater carries a large amount of dissolved oxygen, and enters the biochar substrate layer 7 after passing through the cover layer 5 and the planting layer 6 in sequence. The large molecular organic matters in the cover layer 5 are decomposed into small molecular organic matters that enters the lower layer with the rainwater. In an aerobic environment, the dissolved organic nitrogen in the rainwater is converted to ammonia nitrogen by ammonifying bacteria and partially assimilated by microorganisms and plants in the planting layer 6 (ammonia assimilation means that ammonia is broken down by microorganisms or plants into inorganic nitrogen, which can be utilized by the plant cells to provide essential nitrogen fertilizers for the plants. Typically, ammonia can be assimilated within microbial or plant cells). At the same time, nitrifying bacteria use oxygen as the electron acceptor and ammonia nitrogen as the electron donor, converting part of the ammonia nitrogen produced by ammonification and part of the ammonia nitrogen carried in rainwater into nitrate nitrogen. Meanwhile, due to the complex porous structure of the biochar and the negatively charged surface, positively charged ammonia nitrogen is very easily adsorbed by the biochar. Therefore, most of the ammonia nitrogen in rainwater is effectively removed. In addition, the porous structure of the biochar can effectively retain the dissolved oxygen in the rainwater to ensure the anoxic/anaerobic environment in the lower layer. Subsequently, the nitrogen in the rainwater mainly flows downwardly into the chalcopyrite substrate layer 8 in the form of nitrate nitrogen, flows out through the transition layer 9 and the gravel layer 10, and ultimately enters the rainwater collection area 12. The outlet of the first perforated drainage pipe 11 of the gravel layer 10 is lifted up to the top of the chalcopyrite substrate layer 8, so as to make the gravel layer in a long term submerged state, and prolong the stagnation time to ensure the hypoxic/anaerobic environment. At this stage, the denitrifying bacteria use chalcopyrite as an autotrophic electron donor, the dissolved organic carbon source of the cover layer 5 as a heterotrophic electron donor, and nitrate nitrogen as an electron acceptor, and denitrify nitrate nitrogen to nitrite nitrogen, nitric oxide, and nitrous oxide sequentially under the mixture of autotrophic and heterotrophic effects, and ultimately the nitrogen compounds are reduced into nitrogen discharged out of the system.

2. Reducing nitrous oxide gas emissions: the denitrification process involves four denitrification functional enzymes, that is, nitrate nitrogen reductase, nitrite nitrogen reductase, nitric oxide reductase, and nitrous oxide reductase, among which nitrous oxide reductase is the only enzyme capable of reducing nitrous oxide to nitrogen gas, and its electron-gaining capacity is the weakest among the four enzymes, so nitrous oxide is highly susceptible to accumulation in the process of denitrification of rainwater. As mentioned-above, nitrogen in rainwater flows into the chalcopyrite substrate layer 8 mainly as nitrate nitrogen, where it is retained for anoxic/anaerobic denitrification and denitrification. Chalcopyrite, as a metal mineral, has electrical conductivity, which can play the role of electron shuttle, promoting the electron transfer between the four denitrification function enzymes in the denitrification process, and enhancing the ability of nitrous oxide reductase to get electrons; secondly, nitrous oxide reductase contains a copper-based assistant (the assistant is the cofactor of the enzyme, and metal ions are the most common cofactors of the enzyme), and the lack of copper affects the synthesis and activity of the reductase. Chalcopyrite is oxidized and dissolved by microorganisms to produce copper, which effectively promotes the synthesis of nitrous oxide reductase, improves the activity of nitrous oxide reductase, promotes the reduction of nitrous oxide into nitrogen, and reduces the emission of nitrous oxide from the reaction system.

### Experimental Tests:

Simulated removal of dissolved nitrogen in rainwater and testing of nitrous oxide gas concentration in the bioretention area of the disclosure and traditional sand bioretention area:

Assuming a 120-h antecedent dry duration, the simulated rainwater pollutant concentrations were 3 mg/L nitrate nitrogen, 3 mg/L dissolved organic nitrogen, and 18.2 mg/L chemical oxygen demand (COD), respectively.

Total dissolved nitrogen (TDN) was determined by alkaline potassium persulfate digestion-UV spectrophotometry (HJ 636-2012); nitrate nitrogen was determined by UV spectrophotometry (HJ/T 346-2007); and nitrous oxide gas was determined by static box gas chromatography. The static box gas chromatography is the most commonly used method to measure the exchange flux of trace gases between soil and the atmosphere. Specifically, the gas was collected in situ on the bioretention area with a box, prevented from the exchange with gases outside the box; the gas inside the box was measured over time, and the gas exchange flux was calculated; the gas samples were generally taken at 5 time points, with a 20 min or longer interval between measurements. The emission flux of N₂O is calculated as follows:

$$F = \frac{d c}{dt} \times \frac{M}{{V}_{0}} \times \frac{P}{{P}_{0}} \times \frac{{T}_{0}}{T} \times h ;$$

F is a N₂O gas emission flux (mg/(m²·h)); dc/dt is a change rate of N₂O gas concentration in the static box over time; M is a molar mass of N₂O gas (g/mol); P is a static air pressure inside the box (Pa); T is an average sampling temperature (K); V₀, T₀, and P₀ represent a molar volume (L/mol), temperature (K), and pressure (Pa) of the gas under standard conditions, respectively; H is a static box height above the water surface (m).

The test results are shown in Table 1:

TABLE 1

| | TDN | NO₃⁻N | Emission flux of |
|---|---|---|---|
| | removal | removal | nitrous oxide |
| Facilities | rate (%) | rate (%) | (μg/(m² · h)) |
| Traditional sand | 33.02 | 51.75 | 4.77 |
| bioretention area | | | |
| The disclosure | 55.58 | 84.01 | 2.36 |

As shown in Table 1, the removal efficiency of dissolved nitrogen by the disclosure is superior to that of traditional sand bioretention area, and the emission flux of nitrous oxide gas in the disclosure is significantly lower.

It will be obvious to those skilled in the art that changes and modifications may be made, and therefore, the aim in the appended claims is to cover all such changes and modifications.

What is claimed is:

1. A rainwater garden, comprising:
a bioretention area;
a rainwater collection area; and
a first perforated drainage pipe;
wherein:
the bioretention area comprises, from bottom up, a gravel layer, a transition layer, a chalcopyrite substrate layer, a biochar substrate layer, a planting layer, a cover layer, and a water storage layer; and
the first perforated drainage pipe is disposed in the gravel layer; the first perforated drainage pipe comprises an outlet end extending to connect to the rainwater collection area; and the outlet end is flush with a top surface of the chalcopyrite substrate layer.

2. The rainwater garden of claim 1, further comprising a sedimentation area and an initial runoff disposal area; wherein the sedimentation area and the initial runoff disposal area are disposed outside the cover layer of the bioretention area; the sedimentation area is disposed outside the initial runoff disposal area; pebbles are disposed on bottom parts of the sedimentation area and the initial runoff disposal area; the initial runoff disposal area is sloped; an overflow pipe is vertically disposed in the initial runoff disposal area and a second perforated drainage pipe is disposed flat on a bottom end of the initial runoff disposal area; the overflow pipe is connected to the second perforated drainage pipe; and an outlet of the second perforated drainage pipe is connected to a municipal rainwater pipe network.

3. The rainwater garden of claim 2, wherein a submersible pump is disposed in the rainwater collection area; a return pipe is connected to a water outlet of the submersible pump; an inspection well is disposed on a top end of the rainwater collection area; and a drainage pipe is disposed on a side wall of the rainwater collection area.

4. The rainwater garden of claim 3, wherein the chalcopyrite substrate layer has a thickness of 300-500 mm, filled with a first filler comprising chalcopyrite and quartz sand; a particle size of the chalcopyrite is 0.5-2 mm, and a particle size of the quartz sand is 0.4-0.6 mm; the chalcopyrite and the quartz sand are mixed in a volume ratio of 1:10; and a permeability of the first filler is greater than 250 mm/h.

5. The rainwater garden of claim 4, wherein the biochar substrate layer has a thickness of 200-300 mm, filled with a second filler comprising biochar and quartz sand; the biochar has a particle size of 0.5-1 mm, and the quartz sand has a particle size of 0.4-0.6 mm; the biochar and the quartz sand are mixed in a volume ratio of 1:10; and a permeability of the second filler is greater than 200 mm/h.

6. The rainwater garden of claim 5, wherein the planting layer has a thickness greater than 300 mm and is filled with a third filler comprising sandy loam and quartz sand; a particle size of the sandy loam is 0.1-0.5 mm, and a particle size of the quartz sand is 0.4-0.6 mm; the sandy loam and the quartz sand are mixed in a volume ratio of 1:5; and a permeability of the third filler is greater than 150 mm/h; and the planting layer comprises plants.

7. The rainwater garden of claim 6, wherein the cover layer has a thickness of 50-100 mm, and comprises sawdust, tree bark, or a combination thereof.

8. The rainwater garden of claim 7, wherein the transition layer is a substrate protective layer with a thickness of 50-100 mm, filled with quartz sand with a particle size of 0.4-0.6 mm; the gravel layer is a drainage layer with a thickness of 200-300 mm and a gravel particle size of 50-80 mm.
